(19) United States
(12) Patent Application Publication
(10) Pub. No.: US 2007/0150589 A1
(43) Pub. Date: Jun. 28, 2007

(54) Context-awareness based system supporting autonomous system construction and method of operating the system

(76) Inventors: Won Tae Kim, Daejeon-city (KR); Do Hyung Kim, Daejeon-city (KR); Sun Ja Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/636,047

(22) Filed: Dec. 8, 2006

(30) Foreign Application Priority Data
Dec. 8, 2005 (KR) 10-2005-0119523
Sep. 29, 2006 (KR) 10-2006-0096599

(51) Int. Cl. G06F 15/173

(52) U.S. Cl. 709/224

(57) ABSTRACT

Provided are a context-awareness based system supporting autonomous system construction and a method of operating the system. A context-awareness based user system operating in association with at least one server providing system software and platform software includes a platform manager downloading at least one piece of software required to operate the user system from the server according to a context profile based on context information provided by a sensor and managing the downloaded software; and a profile cache storing at least one profile managed by the platform manager. Accordingly, user convenience can be maximized by autonomously modifying or reconstructing a system software structure in order to cope with various situations that arise when using a single user system.

### CROSS-REFERENCE TO RELATED PATENT APPLICATION

This application claims the benefits of Korean Patent Application No. 10-2005-0119523, filed on Dec. 8, 2005, and Korean Patent Application No. 10-2006-0096599, filed on Sep. 29, 2006, in the Korean Intellectual Property Office, the disclosures of which are incorporated herein in their entirety by reference.

### BACKGROUND OF THE INVENTION

1. Field of the Invention

The present invention relates to a context-awareness based system supporting autonomous system construction and a method of operating the system, and more particularly, to a context-awareness based system supporting autonomous system construction and a method of operating the system, whereby a software configuration can be adaptively changed in response to a current situation of a user or a user system based on a sensor.

2. Description of the Related Art

In the present invention, user systems denote various devices for supporting human activities and providing convenience and include portable terminals, personal robots, etc.

In the present invention, system software denotes a basic system operating software required for an operation of a user system. For example, operating systems (OSs), such as Linux and MS Windows, come under the heading of system software.

In the present invention, platform software denotes middleware for providing transparency in order for an application not to know hardware/system software characteristics of a user system. For example, Wireless Internet Platform for Interoperability (WIPI), Java Virtual Machine (JVM), Open Services Gateway Initiative (OSGi), and Universal Plug and Play (uPnP) come under the heading of middleware.

In general, system software of a user system is manually set by a separate porting stage according to the preference of a user. In this stage, partial functions of the system software are deleted or added according to the determination of the user. In addition, by providing a common Application Programming Interface (API) to an application in order to provide the transparency for various kinds of system hardware and system software, platform software increases portability of an application program and makes the development of new programs easier. However, accompanying the development of various devices and applications, platform software has been being designed and developed to have dynamic scalability.

In order to understand the present specification, a model of extensible platform software is suggested with reference to FIG. 1. FIG. 1 is a schematic diagram of a WIPI platform, which is a Korean Standard wireless Internet platform.

Referring to FIG. 1, a WIPI 103 includes a basic API 104 and a dynamic component 107. The dynamic component 107 allows an API and an execution engine module 105 to be upgraded using dynamic link libraries. A Handset Adaptation Layer (HAL) 106 is a hardware adaptation layer used to smoothly port hardware and has a fixed structure without being included in a platform extension target. A function of downloading an extension API or downloading and managing an application program is accomplished by a program manager 101, wherein the download is performed according to an instruction of a user by means of a Graphic User Interface (GUI). That is, the download is performed and platform software is upgraded according to a user's desire.

A system software 108 is not upgraded and is dependent on a system hardware 109. That is, even if existing system software must be changed in order to provide a function of new platform software that must be supported by system software, the existing system software cannot be modified. In addition, in order to port platform software onto another system software, the HAL 106 of the platform software must be modified, and software settings must be modified according to system hardware characteristics. This cannot be performed by a user and must be supported by a system hardware manufacturer.

Integrity verification of platform software and application programs is performed by a separate verification tool, instead of by the program manager 101, when program is developed.

FIG. 2 is a conceptual diagram for describing a conventional method used when a system user downloads a program or content including an extension component. Referring to FIG. 2, by selecting a target to be downloaded using a GUI of a portable terminal 201, the user downloads the target from a content server 203 having a relevant Uniform Resource Locator (URL) using a Wireless Application Protocol (WAP)/Hypertext Transfer Protocol (HTTP) protocol.

Thus, in a conventional system, it is difficult to autonomously modify platform software according to the context, and a function of changing system software, which is the base of platform software, or modifying a function of the system software is not provided. This is a key problem resulting in the demands of users, who desire to use various situations and services through a single terminal, not being sufficiently met.

### SUMMARY OF THE INVENTION

The present invention provides a context-awareness based system supporting autonomous system construction by obtaining information on current situation of a user or a user system based on a sensor and a method of operating the system.

According to an aspect of the present invention, there is provided a context-awareness based user system operating in association with at least one server providing system software and platform software, the user system comprising: a platform manager downloading at least one piece of software required to operate the user system from the server according to a context profile based on context information provided by a sensor and managing the downloaded software; and a profile cache storing at least one profile managed by the platform manager.

According to another aspect of the present invention, there is provided a context-awareness based system supporting autonomous system construction, the system comprising: a user system receiving and managing dynamic context information from at least one sensor; a resource locator providing a location of context profile information from sensor information detected by the user system; a context profile server providing a context profile suitable for the context of a user or the user system in response to a request of the user system; a platform broker creating a service profile by calculating a software combination optimized based on a system profile and the context profile provided by the user system, downloading software corresponding to the created service profile from a software download server, compiling the downloaded software, and transmitting the compiled software to the user system; the software download server storing various kinds of system software, platform software, and service software in a source or binary level; and a software backup server entirely or selectively backing up software of the user system for the purpose of a software environment change or safety of the user system according to a context change.

According to another aspect of the present invention, there is provided a method of operating a user system operating in association with at least one server providing at least one piece of system software operated by the user system, the method comprising: downloading system software suitable for a basic platform from the server and installing the downloaded system software; downloading optimized software from the server according to context information provided by a sensor and installing and operating the downloaded software as basic platform software; and constituting and operating extended platform software by downloading platform software according to a context change additionally occurring during an operation of the user system and porting the downloaded platform software onto the basic platform software.

According to another aspect of the present invention, there is provided a method of operating a user system, the method comprising: acquiring context information from a sensor and transmitting the acquired context information to a resource locator; receiving a location of a server providing a context profile according to the context information from the resource locator; accessing the context profile server and receiving the context profile; creating a service profile by a platform broker receiving the context profile and a system profile from the user system; the platform broker receiving software corresponding to the service profile from a download server, optimizing the received software to the user system, and transmitting the optimized software to the user system; and the user system receiving the optimized software and verifying and executing the received software.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional platform extension system by which a user directly performs downloading;

FIG. 2 is a conceptual diagram for describing a conventional method used when a system user downloads a program or content including an extension component;

FIG. 3 is a configuration of a context-awareness based system supporting autonomous system construction according to an embodiment of the present invention;

FIG. 4 is an internal configuration of a context-awareness based user system supporting autonomous system construction according to an embodiment of the present invention;

FIG. 5 is a block diagram of a platform manager illustrated in FIG. 4, according to an embodiment of the present invention;

FIG. 6 illustrates an execution screen for selecting a basic platform to initialize a context-awareness based system according to an embodiment of the present invention;

FIG. 7 illustrates an execution screen of an automatic context detection mode of a context-awareness based system according to an embodiment of the present invention;

FIG. 8 is a flowchart illustrating a method of operating a context-awareness based user system according to an embodiment of the present invention;

FIG. 9 is a flowchart illustrating a method of operating a context-awareness based system supporting autonomous system construction according to an embodiment of the present invention; and

FIGS. 10A and 10B are detailed flowcharts of the method illustrated in FIG. 9.

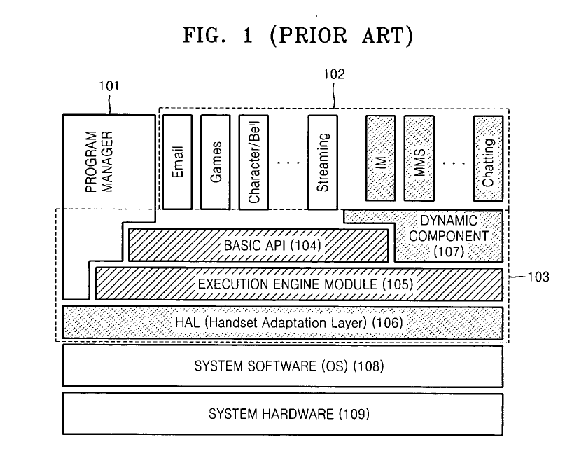

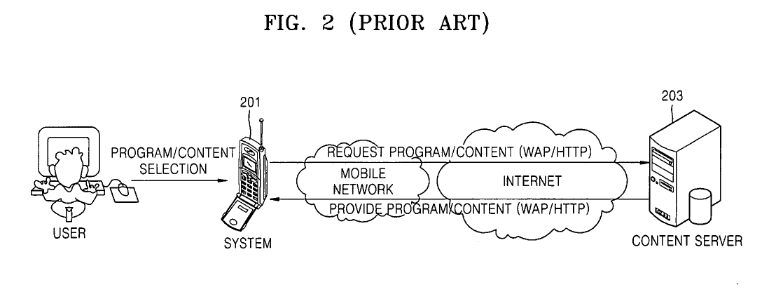

### DETAILED DESCRIPTION OF THE INVENTION

The objectives, characteristics, and merits of the present invention will be described in detail by explaining preferred embodiments of the invention with reference to the attached drawings, and thus, the spirit and scope of the present invention will be easily implemented by those of ordinary skill in the art. In the following description, well-known functions or constructions are not described in detail since they would obscure the invention in unnecessary detail. If necessary for convenience of description, an apparatus and method will be described together. Hereinafter, the present invention will now be described more fully with reference to the accompanying drawings, in which exemplary embodiments of the invention are shown.

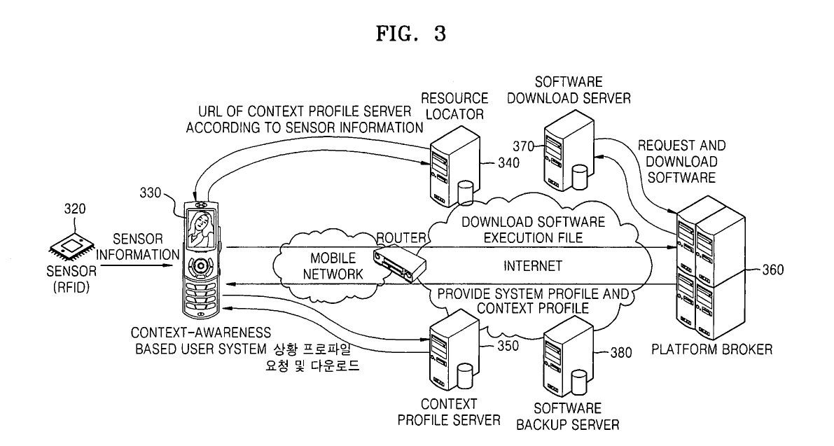

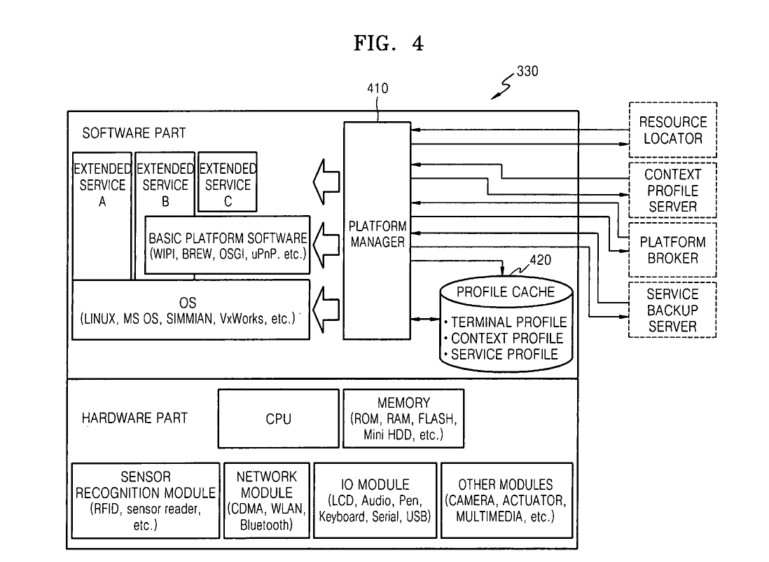

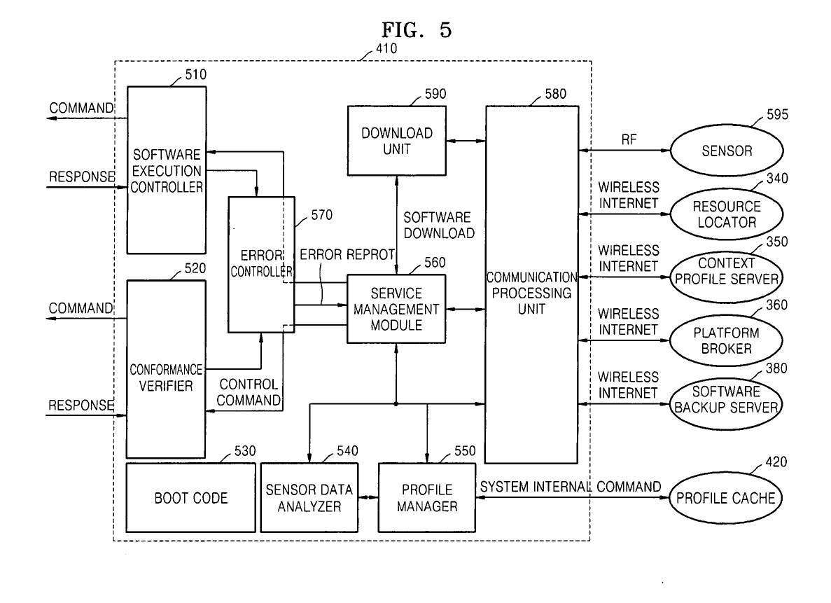

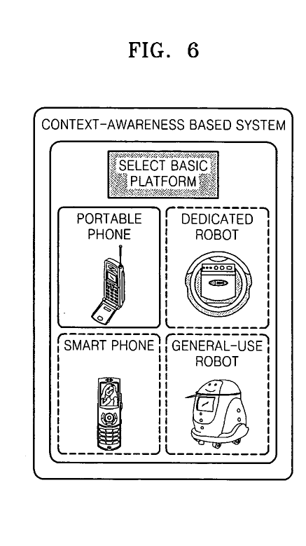

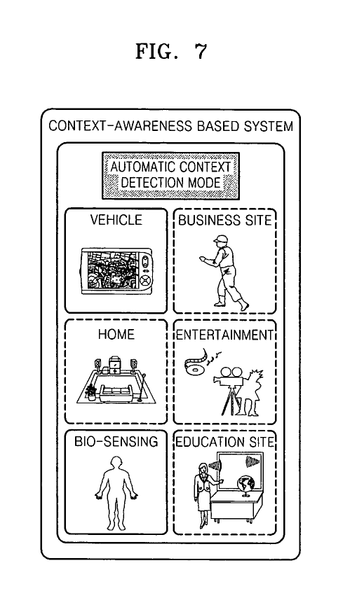

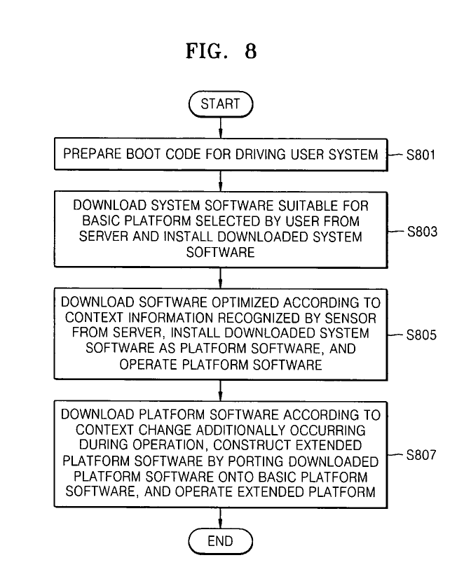

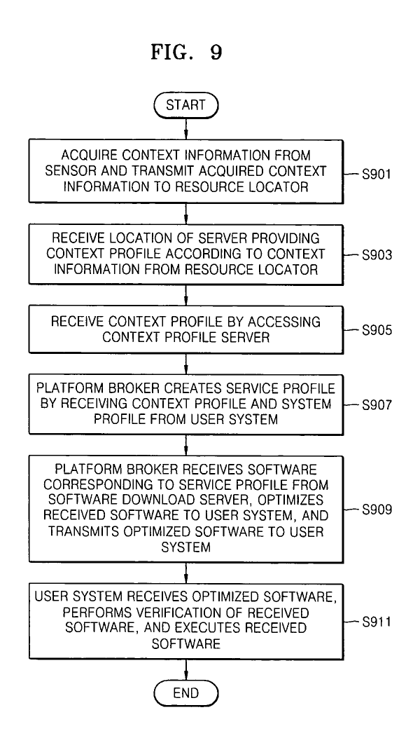

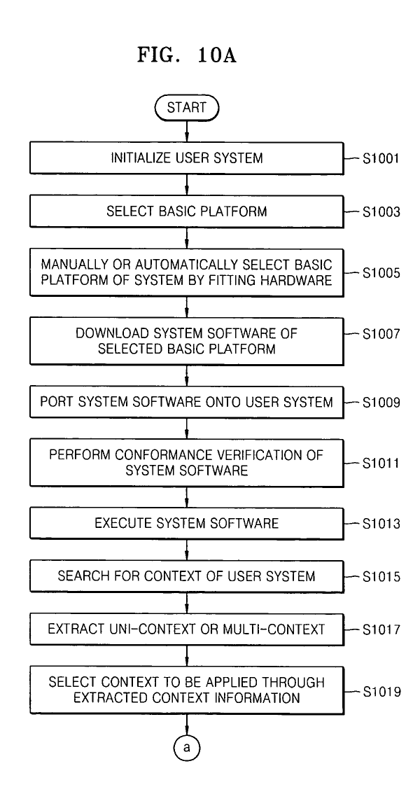

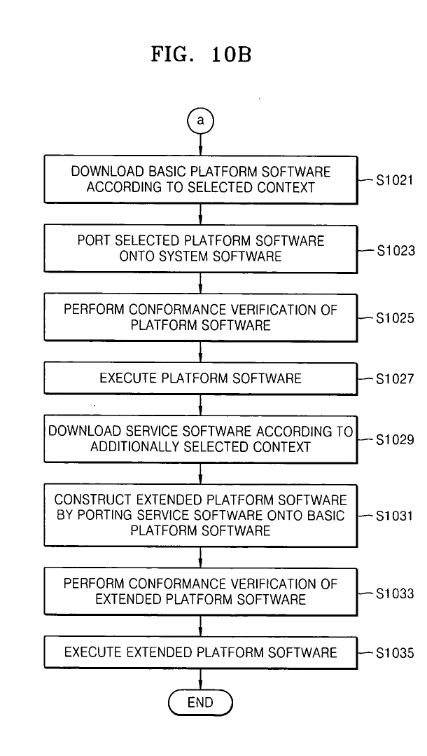

FIG. 3 is a configuration of a context-awareness based system supporting autonomous system construction according to an embodiment of the present invention, FIG. 4 is an internal configuration of a context-awareness based user system supporting autonomous system construction according to an embodiment of the present invention, FIG. 5 is a block diagram of a platform manager illustrated in FIG. 4, according to an embodiment of the present invention, FIG. 6 illustrates an execution screen for selecting a basic platform to initialize a context-awareness based system according to an embodiment of the present invention, FIG. 7 illustrates an execution screen of an automatic context detection mode of a context-awareness based system according to an embodiment of the present invention, FIG. 8 is a flowchart illustrating a method of operating a context-awareness based user system according to an embodiment of the present invention, FIG. 9 is a flowchart illustrating a method of operating a context-awareness based system supporting autonomous system construction according to an embodiment of the present invention, and FIGS. 10A and 10B are detailed flowcharts of the method illustrated in FIG. 9.

Referring to FIGS. 3 and 9, a context-awareness based user system 330, which has received sensor information from a sensor node 320 by means of a sensor recognition module (not shown), transmits the sensor information to a resource locator 340 in operation S901 and receives a Uniform Resource Locator (URL) or an Internet Protocol (IP) address, which is a location of a context profile on the Internet, which is context information according to the sensor information, from the resource locator 340 in operation S903. The user system 330 accesses a context profile server 350, which stores context profiles, using the received location information, provides the sensor information to the context profile server 350, and downloads a context profile corresponding to the sensor information in operation S905. The user system 330 accesses a platform broker 360 and provides the downloaded context profile and a system profile describing a system specification to the platform broker 360. The platform broker 360 creates a service profile in operation S907 by determining a software combination optimized based on the system profile and the context profile provided by the user system 330. The platform broker 360 downloads software corresponding to the created service profile from a software download server 370, compiles the downloaded software to fit the system specification described by the system profile, and transmits the compiled software to the user system 330 in operation S909. The user system 330 constructs a system optimized according to the context by downloading system software, platform software, and service software optimized according to the user system 330 in a binary code format and executing the downloaded system software, platform software, and service software by means of a verification process in operation S911.

The context-awareness based system further includes a software backup server 380 entirely or selectively backing up software of the user system 330 for the purpose of a software environment change or safety of the user system 330 according to a context change. Software stored in the software backup server 380 is used to overcome a limit of the memory of the user system 330 or backup of the user system 330 while being adaptively changed according to various conditions of the user system 330. If the same context profile stored in the software backup server 380 is found, the user system 330 omits the above-described process and performs very quick system restoration by directly accessing the software backup server 380 and downloading existing software from the software backup server 380.

To sum up the context-awareness based system, the user system 330 receives and manages dynamic context information from at least one sensor 320. The resource locator 340 provides a location of a context profile from the sensor information recognized by the user system 330. The context profile server 350 provides a context profile suitable for the context of a user of the user system 330 in response to a request of the user system 330.

The platform broker 360 creates a service profile by calculating a software combination optimized based on a system profile and the context profile provided by the user system 330, downloads software corresponding to the created service profile from the software download server 370, compiles the downloaded software, and transmits the compiled software to the user system 330.

The software download server 370 stores various kinds of system software, platform software, and service software in a source or binary level. The software download server 370 provides the softwares to the platform broker 360 according to the request of the platform broker 360.

The software backup server 380 entirely or selectively backs up software of the user system 330 for the purpose of a software environment change or safety of the user system 330 according to a context change.

FIG. 4 is an internal configuration of the context-awareness based user system 330 supporting autonomous system construction according to an embodiment of the present invention. While the general framework operation has been described with reference to FIG. 3, a configuration of the user system 330 is described with reference to FIG. 4. A hardware part of the user system 330 corresponds to a system installed in a general portable terminal or robot. A software part of the user system 330 includes an OS, basic platform software, and extensible extension service software. A module controlling the software part is a platform manager 410, and a storage unit for storing profiles managed by the platform manager 410 is a profile cache 420. The platform manager 410 communicates with the resource locator 340, the context profile server 350, the platform broker 360, and the software backup server 380 as described above. The platform manager 410 downloads at least one piece of software required to operate the user system 330 from the platform broker 360 according to the context profile created lastly based on context information provided by a sensor and manages the downloaded software. The profile cache 420 stores at least one profile managed by the platform manager 410 and provides the stored profile according to a request of the platform manager 410. The profile cache 420 stores a system profile describing the specification of the user system 330, a context profile describing context information of the user or the user system 330, and a service profile describing information on a software combination optimized based on the system profile and the context profile. Since the other blocks, apart from the platform manager 410 and the profile cache 420, can be understood by those of ordinary skill in the art, a detailed description of the other blocks is omitted.

The platform manager 410 will now be described in more detail with reference to FIG. 5. The platform manager 410 can be divided into several parts. A software execution part (not shown) includes a download unit 590 downloading system software, platform software, and service software for extending the platform software by being specified to context information, a conformance verifier 520 performing verification of the downloaded software, a software execution controller 510 controlling execution of verified software, and an error controller 570 processing an error state generated by the conformance verifier 520 or the software execution controller 510 and outputting the result of the processing.

The platform manager 410 also includes a sensor data analyzer 540 acquiring context information of the user system 330 from a sensor and a profile manager 550 accessing and managing profiles stored in the profile cache 420.

The platform manager 410 also includes a communication processing unit 580 providing interfaces between the user system 330 and the servers described above and a service management module 560 controlling the platform manager 410 and the profile cache 420.

The platform manager 410 must include a boot code 530 by which the user system 330 can basically operate. That is, since a basic OS for operating the system does not exist in a system initialization stage, the platform manager 410 must include the boot code 530 in order to install the above-described software by communicating with the platform broker 360. The boot code 530 must have a simple file transfer protocol, such as Trivial File Transfer Protocol (TFTP), in order to download drivers for using a sensor recognition module and a network module of the system from the platform broker 360. An initial setting stage is performed in a state where a basic system operation including a sensor recognition function and a network function is enabled. A more detailed initial setting process will be described with reference to FIG. 10 later. The sensor data analyzer 540 acquires sensor information from a sensor 595 by communicating with the communication processing unit 580. The acquired sensor information is transmitted to the resource locator 340 by the service management module 560 in order to obtain a URL or an IP address, which is a location of a context profile on the Internet. The service management module 560 transmits the obtained address of the context profile server 350 and a command to the download unit 590 in order to obtain the context profile from the address of the context profile server 350. The download unit 590 downloads necessary data from the platform broker 360 and the service backup server 380 by communicating with the platform broker 360 and the software backup server 380 according to a command of the service management module 560 and transmits the downloaded data to the service management module 560. The profile manager 550 manages the system profile, the context profile and the service profile of the user system 330. The conformance verifier 520 performs verification of downloaded software and performs a conformance test of software ported in the system based on a software test case. The conformance verifier 520 determines whether the downloaded software responds or not, or whether there is a malfunction when a specific test case is executed in the form of command and response. When an error occurs, the error controller 570 processes the error and transmits a final error report to the service management module 560. For software evaluated by the error controller 570 as having no problems or executable errors, the service management module 560 transmits an execution command of the software to the software execution controller 510 so that the software is executed. Communication with the outside of the system is performed by the communication processing unit 580, and serial and Transmission Control Protocol/Internet Protocol (TCP/IP) communication methods are supported.

A method of operating the user system 330 having the configuration illustrated in FIG. 5 will now be described with reference to FIG. 8.

The boot code 530 for driving the user system 330 is prepared in operation S801. At least one selectable basic platform is suggested to the user, a platform selected by the user is set as a basic platform, system software corresponding to the basic platform is requested and received from the servers described above, system porting is performed using the system software, and the system software is verified and executed in operation S803.

A context profile corresponding to context information acquired from a sensor is received, the context profile and the specification of the user system 330 are provided to a server, software optimized according to the user system 330 is received, and the received software is verified and executed in operation S805.

Extended platform software is constituted and operated by downloading platform software according to a context change additionally occurring during an operation of the user system 330 and the downloaded platform software is ported onto the basic platform software in operation S807.

FIG. 6 illustrates a Graphic User Interface (GUI) for selecting a basic platform that is to be used to set a system in an initialization stage of the user system 330. Although the initialization of the user system 330 can be automatically performed based on a system profile, the user may directly select one of various basic platforms, as illustrated in FIG. 6, if necessary. An item surrounded by a solid line indicates a basic platform having priority, and items surrounded by a dotted line indicate available platforms.

FIG. 7 illustrates context information recognized by the user system 330 using a context recognition function. A single context profile or multiple context profiles may be selected. Context profiles surrounded by a solid line, as illustrated in FIG. 7, indicate that a situation where the user gets on a vehicle and operates the user system 330 as a telemetics terminal, and a situation where a bio-sensor is activated to learn a human body are simultaneously recognized. The other context profiles surrounded by a dotted line indicate context profiles that are not recognized even though the context profiles have been previously recognized and relevant software is registered in the software backup server 380.

FIGS. 10A and 10B are flowcharts illustrating a method of constructing an autonomous system based on context recognition. Referring to FIGS. 10A and 10B, when the user system 330 is initially operated, the user system 330 operates the platform manager 410 by entering into a system initialization stage in operation S1001. The user system 330 enters into a basic platform selection stage in operation S1003, and this indicates that the user interface illustrated in FIG. 6 is implemented. A user automatically or manually selects a basic platform of the user system 330 from among viewed items in operation S1005. A system profile corresponding to the selected basic platform is transmitted to the platform broker 360 in order to download system software of the selected basic platform. The platform broker 360 downloads system software suitable for the received system profile from the software download server 370 and compiles the downloaded system software. The platform broker 360 transmits binary code of the compiled system software to the user system 330 in operation S1007. The service management module 560 performs system porting of the system software in operation S1009, performs a conformance test of the system software by performing a verification process in operation S1011, and commands the software execution controller 510 to execute the system software in operation S1013.

In order to construct platform software of the user system 330, the service management module 560 searches for context by using a sensor recognition module (not shown) in operation S1015. As a result, the service management module 560 acquires a single or multiple pieces of activated context information in operation S1017. A context profile is formed by using context information selected by the user or automatically extracted in operation S1019. The service management module 560 requests the platform broker 360 to construct necessary platform software by transmitting the context profile and the system profile to the platform broker 360. The platform broker 360 downloads platform software suitable for the received systemcontext profile from the software download server 370 and compiles the downloaded platform software. The platform broker 360 transmits binary code of the compiled platform software to the user system 330 in operation S1021. The service management module 560 ports the received platform software onto the system software in operation S1023, performs a conformance test of the platform software by performing a verification process in operation S1025, and commands the software execution controller 510 to execute the platform software in operation S1027.

Service software is downloaded when an additionally recognized context profile is added based on the current context profile. Platform software according to context information additionally selected when platform software corresponding to the existing context profile is being executed in the user system 330 is downloaded by using the same procedures as the basic platform software in operation S1029, extended platform software is constructed by porting the service software onto the basic platform software in operation S1031, conformance verification of the extended platform software is performed in operation S1033, and finally the extended platform software is executed in the system software in operation S1035.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, user convenience can be maximized by autonomously modifying or reconstructing a system software structure in order to cope with various situations that arise when using a single user system.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A context-awareness based user system operating in association with at least one server providing system software and platform software, the user system comprising:
a platform manager downloading at least one piece of software required to operate the user system from the server according to a context profile based on context information provided by a sensor and managing the downloaded software; and
a profile cache storing at least one profile managed by the platform manager.

2. The user system of claim 1, wherein the platform manager comprises:
a sensor data analyzer acquiring context information of the user system;
a profile manager accessing and managing profiles stored in the profile cache; and
a software execution unit receiving and executing at least one piece of software.

3. The user system of claim 2, wherein the software execution unit comprises:
a download unit downloading system software, platform software, and service software for extending the platform software by being specified to the context information;
a conformance verifier performing verification of the downloaded software;
a software execution controller controlling execution of verified software; and
an error controller processing an error state generated by the conformance verifier or the software execution controller and outputting the processing result.

4. The user system of claim 2, wherein the platform manager further comprises:
a communication processing unit providing interfaces between the user system and the servers; and
a service management module controlling the platform manager and the profile cache.

5. The user system of claim 1, wherein the user system accesses the sensor using a wireless protocol comprising Radio Frequency Identification (RFID), Zigbee, or Bluetooth.

6. The user system of claim 2, wherein the profile cache stores a system profile describing the specification of the user system, a context profile describing context information of a user or the user system, and a service profile describing information on a software combination optimized based on the system profile and the context profile.

7. A context-awareness based system supporting autonomous system construction, the system comprising:
a user system receiving and managing dynamic context information from at least one sensor;
a resource locator providing a location of context profile information from sensor information detected by the user system;
a context profile server providing a context profile suitable for the context of a user or the user system in response to a request of the user system;
a platform broker creating a service profile by calculating a software combination optimized based on a system profile and the context profile provided by the user system, downloading software corresponding to the created service profile from a software download server, compiling the downloaded software, and transmitting the compiled software to the user system;
the software download server storing various kinds of system software, platform software, and service software in a source or binary level; and
a software backup server entirely or selectively backing up software of the user system for the purpose of a software environment change or safety of the user system according to a context change.

8. The system of claim 7, wherein the user system comprises:
a platform manager downloading at least one piece of software required to operate the user system from the servers according to a context profile based on context information provided by a sensor and managing the downloaded software; and
a profile cache storing at least one profile managed by the platform manager.

9. The system of claim 8, wherein the platform manager comprises:
a sensor data analyzer acquiring context information of the user system;
a profile manager accessing and managing profiles stored in the profile cache; and
a software execution unit receiving and executing at least one piece of software.

10. The system of claim 9, wherein the software execution unit comprises:
a download unit downloading system software, platform software, and service software for extending the platform software by being specified to the context information;
a conformance verifier performing verification of the downloaded software;
a software execution controller controlling execution of verified software; and
an error controller processing an error state generated by the conformance verifier or the software execution controller and outputting the processing result.

11. The system of claim 9, wherein the platform manager further comprises:
a communication processing unit providing interfaces between the user system and the servers; and
a service management module controlling the platform manager and the profile cache.

12. A method of operating a user system operating in association with at least one server providing at least one piece of system software operated by the user system, the method comprising:
(a) downloading system software suitable for a basic platform from the server and installing the downloaded system software;
(b) downloading optimized software from the server according to context information provided by a sensor and installing and operating the downloaded software as basic platform software; and
(c) constituting and operating extended platform software by downloading platform software according to a context change additionally occurring during an operation of the user system and porting the downloaded platform software onto the basic platform software.

13. The method of claim 12, further comprising preparing a boot code for driving the user system before (a) is performed.

14. The method of claim 12, wherein (a) comprises:
(a1) providing at least one selectable basic platform to a user and setting one of the at least one selectable basic platform as a basic platform;
(a2) receiving system software corresponding to the basic platform; and
(a3) performing system porting with the system software, performing verification of the system software, and executing the system software.

15. The method of claim 12, wherein (b) comprises:
(b1) receiving a context profile corresponding to context information acquired from a sensor;
(b2) providing the context profile and the specification of the user system to the server and receiving software optimized according to the user system, which is created by the server; and
(b3) receiving the optimized software, performing verification of the received software, and executing the received software.

16. A method of operating a user system, the method comprising:
(a) acquiring context information from a sensor and transmitting the acquired context information to a resource locator;
(b) receiving a location of a server providing a context profile according to the context information from the resource locator;
(c) accessing the context profile server and receiving the context profile;
(d) creating a service profile by a platform broker receiving the context profile and a system profile from the user system;
(e) the platform broker receiving software corresponding to the service profile from a download server, optimizing the received software to the user system, and transmitting the optimized software to the user system; and
(f) the user system receiving the optimized software and verifying and executing the received software.

17. The method of claim 16, further comprising a backup server entirely or selectively backing up software of the user system and providing the software when a request is received from the user system.

18. A computer readable recording medium storing a computer readable program for executing a method of operating a user system operating in association with at least one server providing at least one piece of system software operated by the user system, the method comprising:
(a) downloading system software suitable for a basic platform from the server and installing the downloaded system software;
(b) downloading optimized software from the server according to context information provided by a sensor and installing and operating the downloaded software as basic platform software; and
(c) constituting and operating extended platform software by downloading platform software according to a context change additionally occurring during an operation of the user system and porting the downloaded platform software onto the basic platform software.

19. A computer readable recording medium storing a computer readable program for executing a method of operating a user system, the method comprising:
(a) acquiring context information from a sensor and transmitting the acquired context information to a resource locator;
(b) receiving a location of a server providing a context profile according to the context information from the resource locator;
(c) accessing the context profile server and receiving the context profile;
(d) creating a service profile by a platform broker receiving the context profile and a system profile from the user system;
(e) the platform broker receiving software corresponding to the service profile from a download server, optimizing the received software to the user system, and transmitting the optimized software to the user system; and
(f) the user system receiving the optimized software and verifying and executing the received software.
